(19) United States
(12) Patent Application Publication
(10) Pub. No.: US 2013/0289829 A1
(43) Pub. Date: Oct. 31, 2013

(54) VEHICLE CONTROL SYSTEM

(71) Applicant: HON HAI PRECISION INDUSTRY CO., LTD., New Taipei (TW)

(72) Inventors: MENG-YU HO, New Taipei (TW); CHIA-CHING HSU, New Taipei (TW)

(73) Assignee: HON HAI PRECISION INDUSTRY CO., LTD., New Taipei (TW)

(21) Appl. No.: 13/851,106

(22) Filed: Mar. 27, 2013

(30) Foreign Application Priority Data
Apr. 25, 2012 (TW) 101114808

(51) Int. Cl. G06F 17/00

(52) U.S. Cl. CPC G06F 17/00
USPC 701/48

(57) ABSTRACT

A vehicle control system includes a portable terminal and a control mechanism mounted on a vehicle. The portable terminal includes a control unit, a first display screen, a first touch screen, a triggering module, and a first communication module. The control mechanism includes a control module, a second communication module, a second touch screen, a second display screen, and a reaction module. When the reaction module is triggered by the triggering module, the control module starts the vehicle and turns on the second display screen and the second touch screen. When the triggering module is removed from the reaction module, the control unit turns on the first display screen and the first touch screen, and controls the first communication module to establish a wireless connection with the second communication module. The control module turns off the second touch screen and the second display screen, and shuts down the vehicle.

### BACKGROUND

1. Technical Field

The present disclosure relates to a control system, and more particularly, to a vehicle control system for controlling multiple functions of a vehicle.

2. Description of Related Art

Vehicles are equipped with multiple function applications, such as GPS navigation capability, parking sensor, and control modules for controlling doors, windows, and trunks of vehicle. As a result, multiple number of buttons should be presented or disposed on the vehicle for controlling such function application components. However, these buttons are distributed in different locations in the vehicle. Thus, passengers and driver need to search to find the buttons and reach out to press the buttons.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a vehicle control system, including a portable terminal and a control mechanism.

FIG. 2 is a function block diagram of the portable terminal of FIG. 1.

FIG. 3 is a function block diagram of the control mechanism of FIG. 1

### DETAILED DESCRIPTION

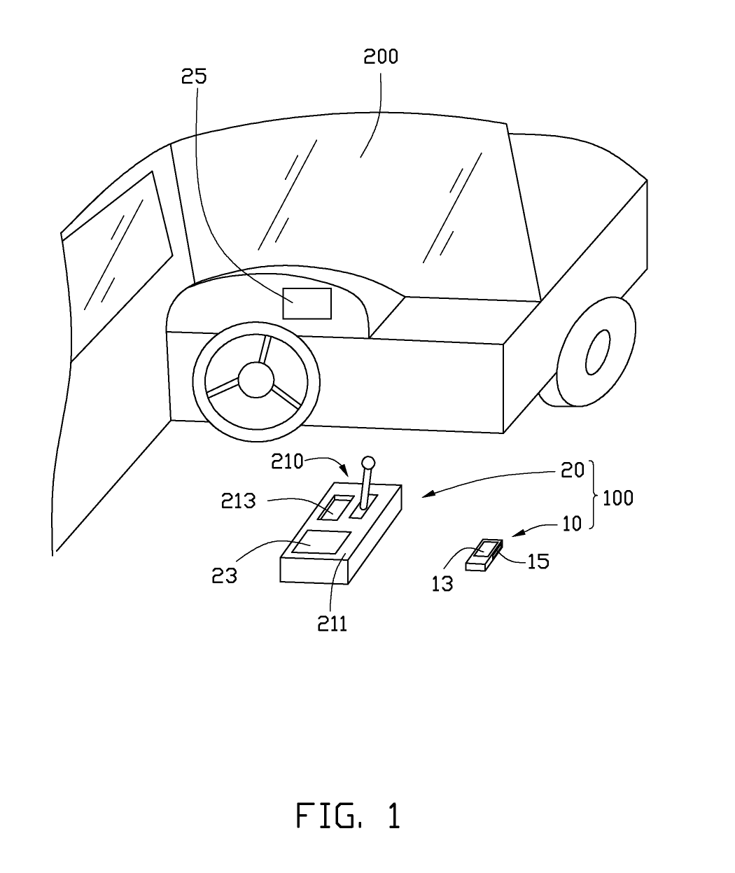

FIG. 1 is an embodiment of a vehicle control system 100. The vehicle control system 100 includes a portable terminal 10 and a control mechanism 20 mounted in a vehicle 200. The vehicle 200 is equipped with a gear shift device 210. The gear shift device 210 includes a casing 211 defining a receiving groove 213. When the portable terminal 10 is placed and received in the receiving groove 213, it starts the vehicle 200 and triggers the control mechanism 20 to be activated. When the portable terminal 10 is taken out or removed from the receiving groove 213, some of the function applications of the vehicle 200 are placed in a disabled state. In the illustrated embodiment, the portable terminal 10 is a key fob. The portable terminal 10 may be in the form of other portable electronic devices, such as a mobile phone.

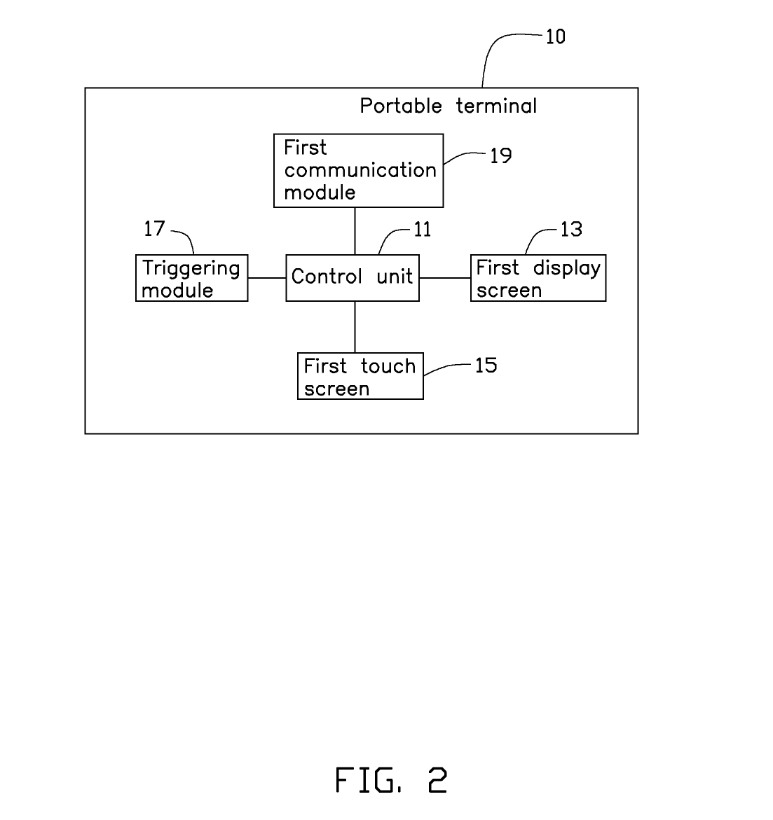

FIG. 2 shows that the portable terminal 10 of the illustrated embodiment includes a control unit 11, a first display screen 13, a first touch screen 15, a triggering module 17 and a first communication module 19. The first display screen 13, the first touch screen 15, the triggering module 17 and the first communication module 19 are electrically connected to the control unit 11, respectively.

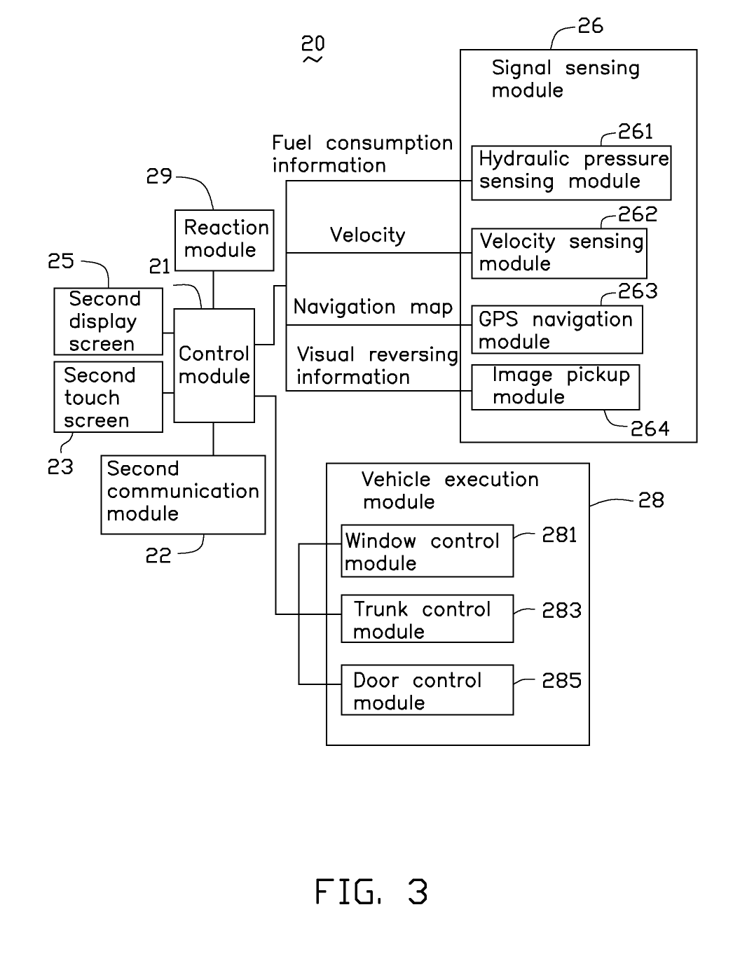

FIG. 3 shows that the control mechanism 20 includes a control module 21, a second communication module 22, a second touch screen 23, a second display screen 25, a signal sensing module 26, a vehicle execution module 28 and a reaction module 29. The second communication module 22, the second touch screen 23, the second display screen 25, the signal sensing module 26, the vehicle execution module 28 and the reaction module 29 are electrically connected to the control module 21, respectively.

In the illustrated embodiment, the second touch screen 23 is mounted on the casing 211 adjacent to the receiving groove 213. A touch command can be generated by touching the second touch screen 23; then the touch command is conveyed or sent to the control module 21; the vehicle execution module 28 controls the function applications of the vehicle 200 based on the touch commands The second display screen 25 is located at a front of the cockpit of the vehicle 200, and displays vehicle information from the signal sensing module 26 via the control module 21.

The signal sensing module 26 and the vehicle execution module 28 are electrically connected to the control module 21. The signal sensing module 26 is mounted on the vehicle 200, and collects information from various function applications or modules, such as vehicle fuel consumption, vehicle velocity, navigation, and visual information, which are then sent to the control module 21; and then the control module 21 sends the corresponding information to the second display screen 25 to be displayed. The displayed information on the second display screen 25 can be paged up by touching the second touch screen 23. The signal sensing module 26 includes a hydraulic pressure sensing module 261, a velocity sensing module 262, a GPS navigation module 263 and an image pickup module 264. The hydraulic pressure sensing module 261 is capable of sensing the fuel consumption information of the vehicle. The velocity sensing module 262 is capable of sensing the velocity of the vehicle 200. The GPS navigation module 263 is capable of accessing a navigation map. The image pickup module 264 is mounted at the rear of the vehicle 200, and is capable of obtaining visual information from the rear of the vehicle 200.

The vehicle execution module 28 includes a window control module 281, a trunk control module 283 and a door control module 285. These three control modules send the information gathered regarding the current operating state or condition of the window, the trunk and the door to the control module 21 and display the gathered information on the second display screen 25. By touching the second touch screen 23, commands can be generated and sent to the control module 21, thereby controlling the window, the trunk, and the door to lock or open via the window control module 281, the trunk control module 283, and the door control module 285 correspondingly and respectively.

When the portable terminal 10 is received in the receiving groove 213, the triggering module 17 receives induction information from the reaction module 29 and sends the corresponding information to the control unit 11 to turn off the first display screen 13, the first touch screen 15 and the first communication module 19. At the same time, the reaction module 29 is triggered by the triggering module 17 and sends vehicle information to the control module 21 to start the vehicle 200, and turn on the second touch screen 23 and the second display screen 25, the control module 21 receives information from the reaction module 22 to turn off the second communication module 22.

When the portable terminal 10 is extracted from the receiving groove 213, the control unit 11 receives induction information from the reaction module 29, thereby turning on the first display screen 13 and the first touch screen 15. The control unit 11 further controls the first communication module 19 to establish a short-range wireless connection and communication with the second communication module 22. The first communication module 19 receives vehicle information from the control unit 11 via the second communication module 22, and sends the vehicle information to the first display screen 13 to be displayed. Meanwhile, the reaction module 29 senses the departing of the triggering module 17, and sends information to the control module 21 to turn off the second touch screen 23 and the second display screen 25, and shuts down the vehicle 200.

When the vehicle 200 is to be started, the portable terminal 10 establishes a communication with the control mechanism 20. The information regarding the function application status and states of the vehicle can be checked or inspected via the first display screen 13; by touching the first touch screen 15, function applications of the vehicle 200 can thereby be controlled. When the portable terminal 10 is inserted into the receiving groove 213, the vehicle 200 is started, and the second display screen 25 displays information. The window, the door, and the trunk can be locked or released by touching the second touch screen 23.

Benefiting from having the second display screen 25 and the second touch screen 23, vehicle information can be displayed on the second display screen 25, and control of the operating functions or function applications of the window, the door, and the trunk can be accomplished by touching the second touch screen 23, such that an operator can control the operating functions or function applications of the vehicle more conveniently. The portable terminal 10 is capable of turning on the control mechanism 20 to control the operating functions or function applications of the vehicle 200. When leaving the vehicle 200, the operator is capable of controlling the functions of the vehicle 200 remotely using the portable terminal 10.

A button may be mounted on the casing 211 of the gear shift device 210, the button can be pressed to trigger the reaction module 29, so as to start the control mechanism 21, under this situation and configuration, the triggering module 17 can be omitted. The signal sensing module 26 can be expanded by having additional multiple numbers of function applications, such as adding of a road condition sensing module, a vehicle temperature sensing module, a displacement sensing module for calculating a total mileage of the vehicle 200, and a video capturing module for capturing and recording the driving experience and video footage.

The receiving groove 213 may be defined in other places in the vehicle, such as on the front dashboard of the cockpit. The second display screen 25 also can be located in other places of the vehicle favored by the operator. In the embodiment, the reaction module 29 is located at a bottom of the receiving groove 213, meanwhile in other embodiments, the reaction module can be located in a location that is favored by the operator.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A vehicle control system, comprising:
a portable terminal, comprising:
a control unit, a first display screen, a first touch screen, a triggering module and a first communication module, the first display screen, the first touch screen, the triggering module and the first communication module being electrically connected to the control unit, respectively; and
a control mechanism mounted on a vehicle, comprising:
a control module, a second communication module, a second touch screen, a second display screen and a reaction module, the second communication module, the second touch screen, the second display screen and the reaction module being electrically connected to the control module;
wherein when the reaction module is triggered by the triggering module, the reaction module sends vehicle information to the control module to start the vehicle, and turns on the second display screen and the second touch screen, the second display screen displays vehicle information and a plurality of operating functions for the vehicle are controlled by touching the second touch screen, the triggering module receives an induction information from the reaction module and sends the corresponding induction information to the control unit to turn off the first display screen and the first touch screen;
when the triggering module is departed as being sensed by the reaction module, the control unit receives induction information from the reaction module, and turns on the first display screen and the first touch screen of the portable terminal, the control unit controls the first communication module to establish a short-range wireless connection with the second communication module, the reaction module sends information to the control module to turn off the second touch screen and the second display screen of the control mechanism, and shuts down the vehicle.

2. The vehicle control system of claim 1, wherein the control mechanism further comprises a signal sensing module electrically connected to the control module, the signal sensing module is mounted on the vehicle, and collects a plurality of information from a plurality of function modules, when the reaction module is triggered, the signal sensing module sends the plurality of information to the control module, and then the control module sends the plurality of information to the second display screen to display.

3. The vehicle control system of claim 2, wherein the signal sensing module comprises a hydraulic pressure sensing module, a velocity sensing module, a GPS navigation module and an image pickup module, the hydraulic pressure sensing module is capable of sensing the fuel consumption information of the vehicle, the velocity sensing module is capable of sensing the velocity of the vehicle, the GPS navigation module is capable of obtaining access to a navigation map, the image pickup module is mounted at the rear of the vehicle, and is capable of obtaining visual information from the rear of the vehicle, the corresponding fuel consumption, velocity, navigation, and visual information are sent by the control module to the second display screen to display, the information on the second display screen capable of being paged up by touching the second touch screen .

4. The vehicle control system of claim 1, wherein the control mechanism further comprises a vehicle execution module connected to the control module, the vehicle execution module comprises a window control module, a trunk control module and a door control module, the window control module, the trunk control module and the door control module sending information gathered regarding a current operating state of the window, the trunk and the door to the control module, respectively, when the reaction module is triggered, the information is displayed on the second display screen, touching the second touch screen, commands are generated and sent to the control module, thereby controlling the window, the trunk and the door to lock or release via the window control module, the trunk control module and the door control module correspondingly and respectively.

5. The vehicle control system of claim 1, wherein when the reaction module is triggered by the triggering module, the reaction module sends information to the control module to turn off the second communication module, the triggering module sends information to the control unit to turn off the first communication module.

6. The vehicle control system of claim 5, wherein the vehicle defines a receiving groove thereon, and the reaction module is received in the receiving groove, when the portable terminal inserts into the receiving groove, the reaction module is triggered by the triggering module and starts the vehicle.

7. The vehicle control system of claim 6, wherein when the portable terminal is extracted from the receiving groove, the control unit receives induction information from the reaction module, thereby turning on the first display screen and the first touch screen, the control unit controls the first communication module to establish a short-range wireless connection with the second communication module, the first communication module receives one or more information from the second communication module, and sends the one or more information to the first display screen to be displayed, the reaction module senses the departure of the triggering module, and sends information to the control module to turn off the second touch screen and the second display screen, and shuts down the vehicle.

8. The vehicle control system of claim 6, wherein the vehicle is equipped with a gear shift device, the gear shift device comprises a casing, the receiving groove is defined on the casing, the second touch screen is mounted on the casing adjacent to receiving groove.

9. A vehicle control system, comprising:
a portable terminal, comprising:
a control unit, a first display screen, a first touch screen, a triggering module and a first communication module, the first display screen, the first touch screen, the triggering module and the first communication module being electrically connected to the control unit, respectively; and
a control mechanism mounted on a vehicle, comprising:
a control module, a second communication module, a second touch screen, a second display screen and a reaction module, the second communication module, the second touch screen, the second display screen and the reaction module being electrically connected to the control module;
wherein when the reaction module is triggered by the triggering module, the control module starts the vehicle, and turns on the second display screen and the second touch screen, such that the second display screen displays vehicle information and a plurality of operating functions for the vehicle are controlled by touching the second touch screen;
when the triggering module is removed from the reaction module, the control unit turns on the first display screen and the first touch screen of the portable terminal, the first communication module establishes a short-range wireless connection with the second communication module, the control module turns off the second touch screen and the second display screen of the control mechanism, and shuts down the vehicle.

10. The vehicle control system of claim 9, wherein the control mechanism further comprises a signal sensing module electrically connected to the control module, the signal sensing module is mounted on the vehicle, and collects a plurality of information, when the reaction module is triggered by the triggering module, the signal sensing module sends the plurality of information to the control module, and then the control module sends the plurality of information to the second display screen to display.

11. The vehicle control system of claim 10, wherein the signal sensing module comprises a hydraulic pressure sensing module, a velocity sensing module, a GPS navigation module and an image pickup module, the hydraulic pressure sensing module is capable of sensing the fuel consumption information of the vehicle, the velocity sensing module is capable of sensing the velocity of the vehicle, the GPS navigation module is capable of obtaining access to a navigation map, the image pickup module is mounted at the rear of the vehicle, and capable of obtaining visual information at the rear of the vehicle, the corresponding fuel consumption, velocity, navigation, and visual information are sent by the control module to the second display screen to display, the information on the second display screen is capable of being paged up by touching the second touch screen.

12. The vehicle control system of claim 9, wherein the control mechanism further comprises a vehicle execution module connected to the control module, the vehicle execution module comprises a window control module, a trunk control module and a door control module, the window control module, the trunk control module and the door control module sending the information gathered regarding a current operating state of the window, the trunk and the door to the control module, respectively, when the reaction module is triggered, the information is displayed on the second display screen, touching the second touch screen, commands are generated and sent to the control module, thereby controlling the window, the trunk and the door to lock or release via the window control module, the trunk control module and the door control module correspondingly and respectively.

13. The vehicle control system of claim 9, wherein when the reaction module is triggered by the triggering module, the reaction module sends information to the control module to turn off the second communication module, the triggering module sends information to the control unit to turn off the first communication module.

14. The vehicle control system of claim 13, wherein the vehicle defines a receiving groove thereon, the reaction module is received in the receiving groove, when the portable terminal inserts into the receiving groove, the reaction module is triggered by the triggering module and starts the vehicle.

15. The vehicle control system of claim 14, wherein when the portable terminal is extracted from the receiving groove, the control unit receives induction information from the reaction module, thereby turning on the first display screen and the first touch screen, the control unit controls the first communication module to establish a short-range wireless connection with the second communication module, the first communication module receives one or more information from the control unit via the second communication module, and sends the one or more information to the first display screen to display, the reaction module senses the departure of the triggering module, and sends information to the control module to turn off the second touch screen and the second display screen, and shuts down the vehicle.

16. The vehicle control system of claim 14, wherein the vehicle is equipped with a gear shift device, the gear shift device comprises a casing, the receiving groove is defined on the casing, the second touch screen is mounted on the casing adjacent to the receiving groove.
